(19) United States
(12) Patent Application Publication
(10) Pub. No.: US 2014/0123039 A1
(43) Pub. Date: May 1, 2014

(54) Auto Localization

(71) Applicant: Apple Inc., Cupertino, CA (US)

(72) Inventors: Ali T. Ozer, Redwood City, CA (US); Peter C. Ammon, San Jose, CA (US); Kristin M. Forster, Los Altos, CA (US); Jonathan J. Hess, Los Altos, CA (US); Ken Ferry, Pasadena, CA (US)

(73) Assignee: Apple Inc., Cupertino, CA (US)

(21) Appl. No.: 13/950,229

(22) Filed: Jul. 24, 2013

Related U.S. Application Data
(60) Provisional application No. 61/719,345, filed on Oct. 26, 2012.

(51) Int. Cl. G06F 3/048

(52) U.S. Cl. CPC G06F 3/048
USPC 715/762

(57) ABSTRACT

Exemplary methods, apparatuses, and systems receive a preferred language and a base file that includes localizable and non-localizable user interface objects, the text string associated with the localizable user interface objects, and the respective ID codes of the user interface objects. Substitute the text string of localizable user interface objects in the base file with the text string in a localization text file referenced by the ID code. Generate a user interface window with the user interface objects including the text from the localization text file.

This application claims the benefit of U.S. Provisional Patent Application No. 61/719,345, filed Oct. 26, 2012. The disclosure of the above application is incorporated by reference herein in its entirety.

### FIELD

The various embodiments described herein relate to apparatuses, systems, and methods to localize a graphical user interface. In particular, the embodiments relate to the localization of the graphical user interface that uses a single base file and a plurality of localization text files.

### BACKGROUND

Designing a graphical user interface (“GUI”) for an application using a graphical user interface layout systems can be complex. The process is further complicated by the fact that applications today are marketed to a global audience. Such applications are customized for each target market. In particular, each user interface object within a GUI that contains text must be localized, e.g., translated from one language to one or more languages depending on the target market.

Existing layout systems allow a developer to create the layout of the GUI and provide the relevant text for each user interface object that requires it. However, the localization process is rather cumbersome. By way of example, a developer using a conventional layout system typically would have to copy the entire base file to another working area, open the copy of the base file in the new working area, and manually edit the user interface objects and translate the text in the new base file. This process is repeated for each of the target language. If the original base file is subsequently modified, e.g., a button is deleted or a text string is updated, then the entire process of generating localized base files has to be repeated for each target language.

Moreover, the translated text string may be much longer than the original text string. In order to maintain the visual appearance of the user interface object containing the longer, translated text string, the user interface object is increased in size. The size increase of the user interface object, in turn, affects the overall layout of the GUI. With different sized user interface objects and corresponding different overall layouts, developers have used one base file for each target language to enable the developer to manually adjust the layout for each localization language. Additionally, when the resulting application is executed by the user at run time, the appropriate base file would be executed, depending on the user's preferred language.

Applications built using the described layout systems, therefore, often include multiple base files. Each base file needs to be updated whenever any change is made to the layout or text within the layout. It would be advantageous to have a layout system that uses a single base file for the physical placement and connection of the user interface objects for all languages supported by the application, and the base file referencing one of the localization text files for the purpose of displaying the application in a particular preferred language.

### SUMMARY OF THE DESCRIPTION

Exemplary methods, apparatuses, and systems include receiving a preferred language and a single base file, wherein the base file includes one or more user interface objects, wherein the one or more user interface objects is localizable or non-localizable. In one embodiment, the single base file is the only base file used by the methods, apparatuses, and systems in determining how to display the user interface objects in the user interface window for all the languages supported. In one embodiment, this information includes the size and relative positions of the user interface objects in the user interface window. In one embodiment, the methods, apparatuses, and systems further include determining the identification (ID) code in the single base file that corresponds to a localizable user interface object, in response to determining that the user interface object is localizable. In another embodiment, the methods, apparatuses, and systems also include accessing a localization text file according to the preferred language, and determining a text string in the localization text file that corresponds to the ID code. Moreover, the methods, apparatuses, and systems include substituting the text string for the localizable user interface object in the base file with the text string from the localization text file, and generating a user interface window with the localizable user interface object including the text from the localization text file.

Additionally, exemplary methods, apparatuses, and systems include receiving user input to move, resize, or add one or more user interface objects to a user interface window, wherein the user interface objects is localizable or non-localizable, and receiving a set of one or more display languages, such that the user interface window and the localizable user interface objects can be displayed in one of the display languages. In one embodiment, the methods, apparatuses, and systems include generating a single base file that stores the user interface window and the localizable user interface objects, wherein the base file associates each localizable user interface object with a unique ID code, and a text string. In another embodiment, the methods, apparatuses, and systems include determining the ID code in the base file that corresponds to a localizable user interface object, of each user interface object that is determined to be localizable, and generating a localization text file for one or more of the received set of display languages, wherein the localization text file includes the ID code for each localizable user interface object in the base file, and a respective text string.

In one embodiment, the text string included in the generated localization text string file is the text string in the base file that is translated to the language selected from the set of display languages.

### BRIEF DESCRIPTION OF THE DRAWINGS

The present invention is illustrated by way of example and not limitation in the figures of the accompanying drawings, in which like references indicate similar elements, and in which:

FIG. 1 illustrates an exemplary developer interface window used in the design layout system described herein;

FIG. 2 illustrates the exemplary developer interface window of FIG. 1 receiving input to add a user interface window.

FIG. 3 illustrates the exemplary developer interface window of FIG. 2 receiving input to add user interface objects to the user interface window;

FIG. 4 illustrates the exemplary GUI window of FIG. 3 receiving input to add text strings to localizable user interface objects;

FIG. 5 illustrates the exemplary base file generated for the GUI window of FIG. 4;

FIG. 6 illustrates the exemplary French localization text file automatically generated based on the base file of FIG. 5;

FIG. 7 illustrates the exemplary French localization text file of FIG. 6, after a manual edit has been made to a text string.

FIG. 8 illustrates the exemplary GUI window of FIG. 4 after an existing user interface object has been deleted and a new user interface object has been added;

FIG. 9 illustrates an exemplary base file generated based on the GUI window of FIG. 8;

FIG. 10 illustrates the exemplary French localization text file that is completely regenerated according to the base file of FIG. 9;

FIG. 11 illustrates the exemplary French localization text file that is partially regenerated according to the base file of FIG. 9;

FIG. 12 illustrates a file referencing structure of an application resulting from the exemplary GUI window of FIG. 8;

FIG. 13 is a flow chart that illustrates an exemplary method of generating a user interface window with localizable user interface objects including text from the localization text file;

FIG. 14 is a flow chart that illustrates an exemplary method of generating a single base file and a plurality of localization text files; and

FIG. 15 illustrates, in block diagram form, an exemplary processing system to generate a user interface window with localizable user interface objects and generate a single base file and corresponding localization text files.

### DETAILED DESCRIPTION

Various embodiments and aspects of the invention(s) will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

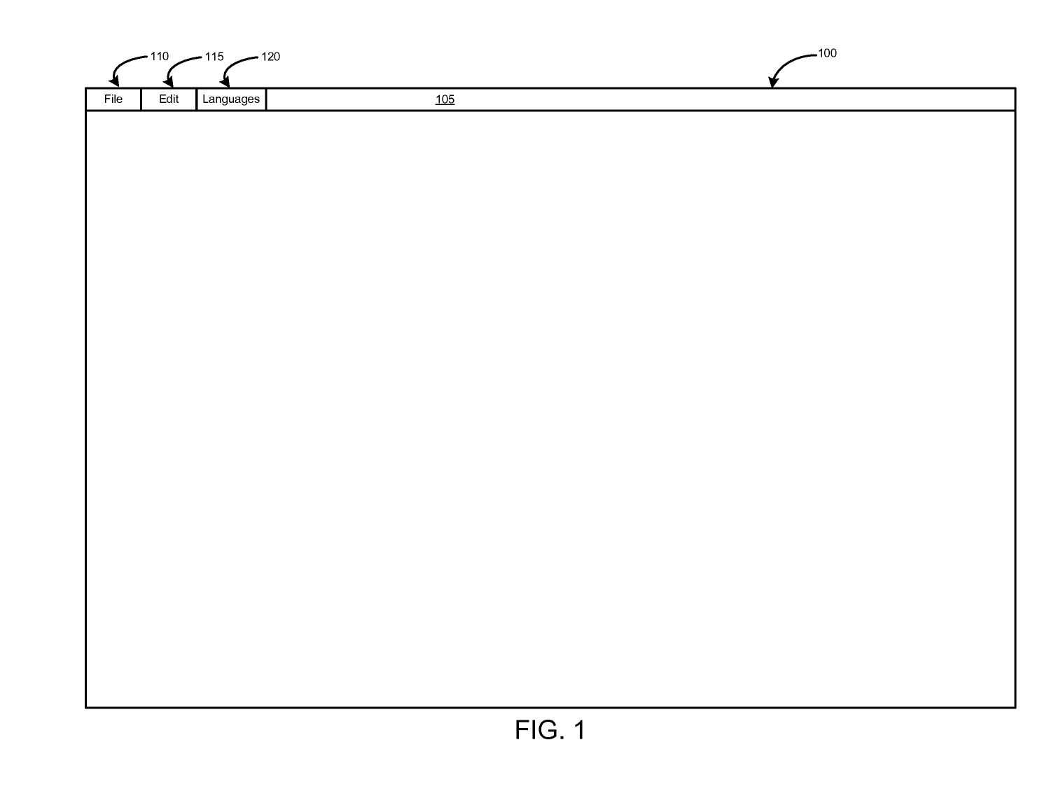

FIG. 1 illustrates an exemplary developer interface window 100 used in the design layout system described herein. For example, the developer interface window 100 is a part of integrated development environment or other software development tool running on a data processing system. In one embodiment, the developer interface window 100 includes a menu bar 105, which includes the File menu 110, Edit menu 115, and Languages menu 120. In one embodiment, when a developer places the mouse cursor over one of the menus 110, 115, or 120 and presses on the left button of the mouse, the menu pulls down and provides further menu options. Each menu option would allow the developer to perform a particular function (discussed in more details below.) In another embodiment, the developer performs the functions by pressing on a combination of keyboard buttons, giving a speech command, selecting a button, etc.

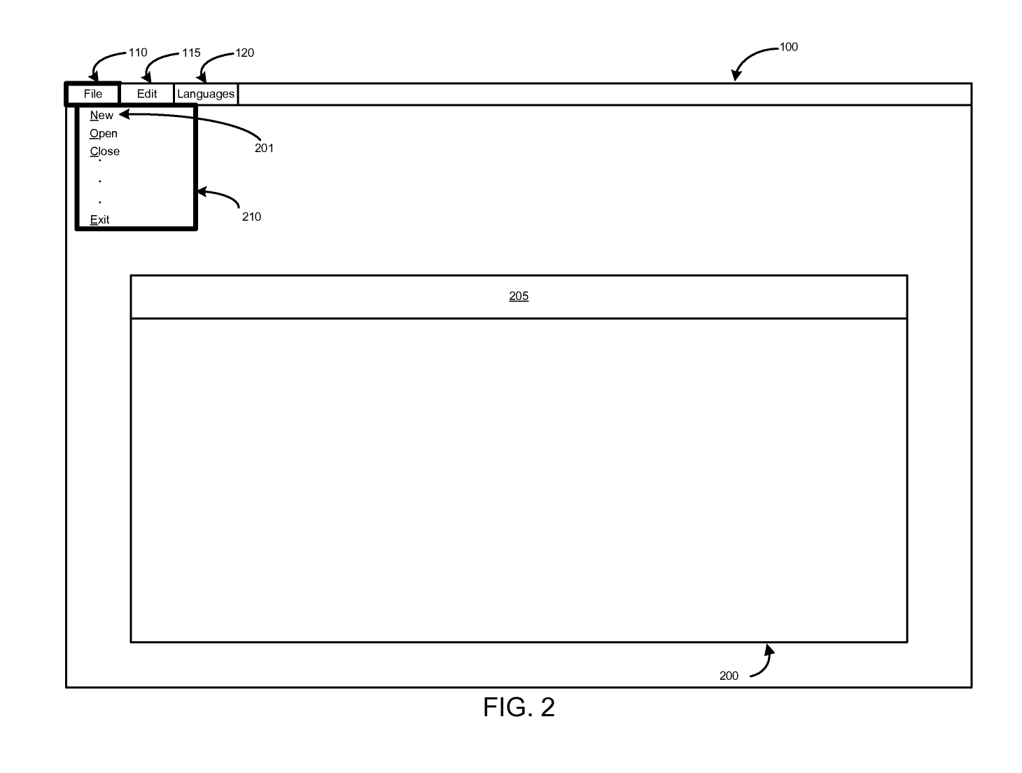

FIG. 2 illustrates the exemplary developer interface window 100 of FIG. 1 receiving input to add a GUI window 200. In one embodiment, the GUI window 200 is selected from a template or palette of windows. In one embodiment, the GUI window 200 is added to the developer interface window 100 by selecting the “New” submenu 201 of the drop-down menu 210. Alternatively, the GUI window 200 is added to the developer interface window 100 by pressing on a combination of keys on the keyboard, selecting a button, etc. In one embodiment, the GUI window 200 includes default user interface objects such as a header bar 205. Alternatively, the GUI window 200 does not include any default user interface objects.

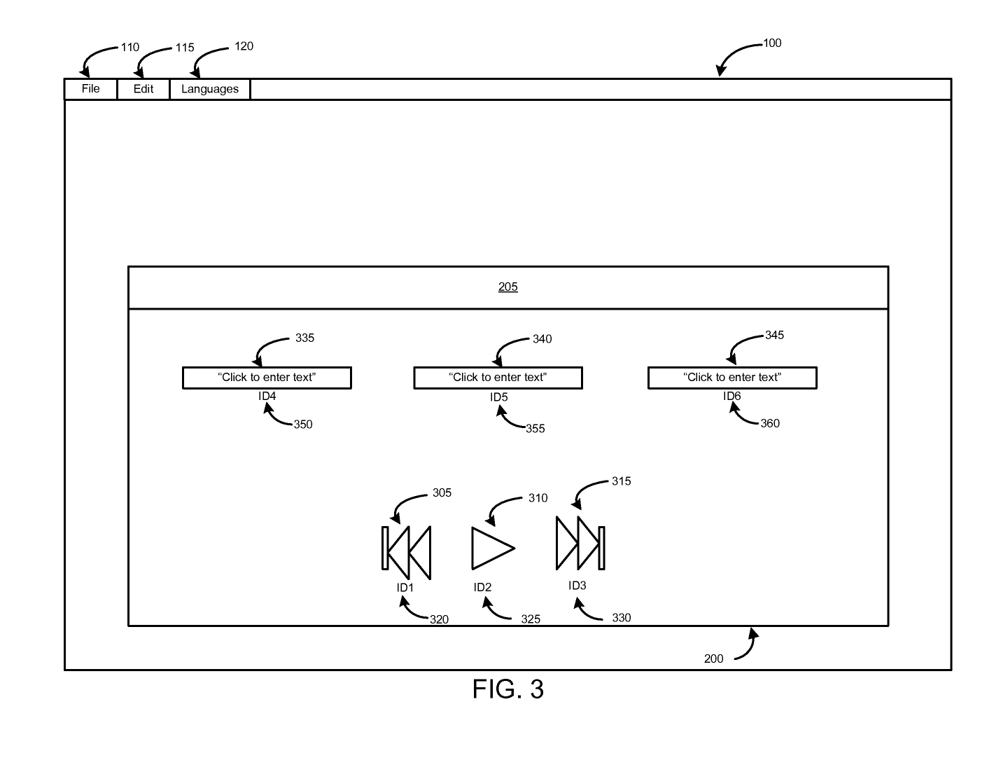

FIG. 3 illustrates the exemplary GUI window 200 of FIG. 2 after the user interface objects 305, 310, 315, 335, 340, and 345 have been placed in a position within the GUI window 200. In one embodiment, the user interface objects 305, 310, and 315 are non-localizable objects because they do not/cannot include text to be translated (e.g., they do not include the label “Click to enter text”). Similarly, objects 335, 340, and 345 are localizable objects because they do/will include text to be translated (e.g., they include the label “Click to enter text”) In one embodiment, the user interface objects that have been placed in the GUI window 200 are automatically assigned an identification code (ID). In an alternate embodiment, the ID for each user interface object is manually assigned by the developer. In the GUI window 200, the user interface objects 305, 310, 315, 335, 340, and 345 have been assigned ID1 320, ID2 325, ID3 330, ID4 350, ID5 355, and ID6 360, respectively.

In one embodiment, each user interface object is assigned to a particular class of objects. For example, a user interface object that is of a menu type belongs to a particular object class, while a user interface object that provides audio or video playback may belong to a different object class.

User interface objects are either localizable or non-localizable. A non-localizable object is an object that does not vary based upon a selected language. A localizable object, however, varies depending upon a selected language. Additionally, a localizable object may vary in size, depending, e.g., on the length of various translations of the text string associated with the object. For instance, a localizable user interface object is a user interface object that allows the developer the option of labeling it with text that will be displayed along with the user interface object when the GUI window 200 is executed at run time of the application. The text may be translated, depending upon a language preference determined prior to or at run time of the application. A non-localizable user interface object is one that may or may not include “static” text (if text is included, it is not translated based upon the language preference).

In one embodiment, the text strings of localizable user interface objects belong to a particular subclass. For example, a button in the GUI may belong to an object class, and if the button includes localizable text, then the localizable text string would belong to a particular subclass. In one embodiment, multiple object classes use or reference object instances of this special subclass because multiple types of user interface objects include a text string, i.e., multiple types of buttons, menus, etc. may include text strings. In one embodiment, at the time when the interface is presented to the user, the special subclass substitutes the translated text string in place of its default contents.

In one embodiment, a developer may enter text for a localizable user interface object through the use of the menu options 110, 115, or 120. For example, a developer may left-click on the mouse button while the cursor is hovering over the Edit menu 115, which causes the Edit menu 115 to pull down and provide the developer with submenu options, similar to the pull down menu 210 of FIG. 2. In one embodiment, a submenu option is provided which would enable the developer to enter text for a particular user interface object, by selecting the ID of the object, and causing a dialogue box to be displayed, which allows the text to be entered.

In one embodiment, text may be entered for a localizable user interface object by left-clicking on the mouse button while the mouse cursor is hovering over the area configured to receive text within the user interface object, e.g., the illustrated “Click to enter text” label, text previously entered within the user interface object, or otherwise in a blank area configured to receive text. In one embodiment, a dialogue box would be generated so that the developer may enter the text to be displayed with the object. In an alternate embodiment, the developer may enter the text directly on the user interface object after clicking on the “Click to enter text” label.

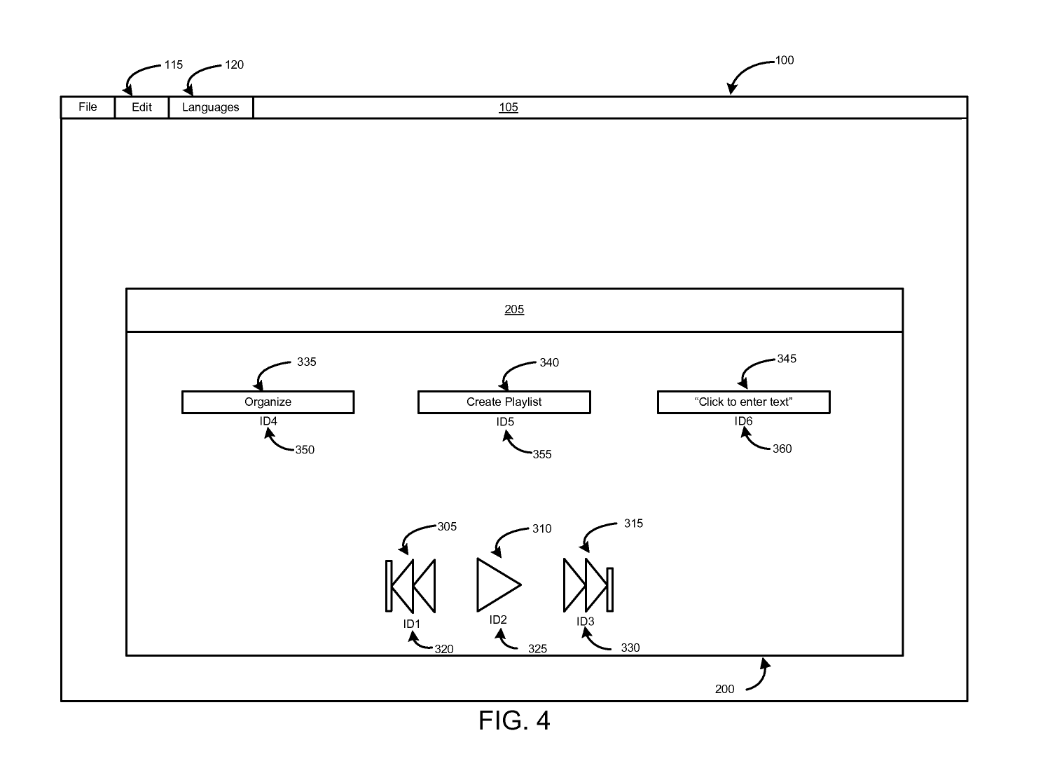

FIG. 4 illustrates the exemplary GUI window 200 of FIG. 3 after the developer has entered the text string “Organize” for localizable user interface object 335, and the text string “Create Playlist” for localizable user interface object 340, e.g., by using one of procedures described above. In one embodiment, a developer may elect not to provide text for one or more localizable user interface objects. For example, FIG. 4 illustrates that the developer has elected not to enter text for localizable user interface objet 345.

Localization is a process that includes translating text for a localizable user interface object from one language to another. In one embodiment, localization is performed for all languages supported by the layout system. In an alternate embodiment, localization is only performed for the languages the user provides (e.g., as input to the layout system). In one embodiment, the developer provides such input through the menu options on the menu bar 105. For example, a developer may left-click on the mouse button while the mouse cursor is hovering over the Languages menu option 120, which would cause a pull down menu to be displayed. In one embodiment, the pull down menu includes selectable display languages supported by the layout system, e.g., with a check box to the right or left of each language title. The developer would select the languages for which localization text files are to be generated by left-clicking on the boxes next to the language title. In one embodiment, the pull down menu includes an option to allow localization to all languages supported by the layout system.

Localization is a process that is “relative” and requires a reference starting point. In other words, in order for a text string to be translated to a second language, the translator must know the first language of the text, i.e., the development language. In one embodiment, the default development language is English. It will be appreciated, however, that the default development language may be any language supported by the layout system. In one embodiment, the translator is a person who manually translates the text of each localizable object from the development language to other one or more languages. In another development, the translator is a machine, e.g., a computer system that automatically translates the text of localizable user interface objects. For example, in such an embodiment, when the user instructs the layout system to generate the localization text files, the translation is automatically performed by the layout system generating machine translations of localizable text to be included in the corresponding generated localization text files.

In one embodiment, the layout system allows the developer to specify the development language, e.g., through the menu options available on the menu bar 105 or by another means known in the art. For example, the developer may left-click on the mouse while the mouse cursor is hovering over the Edit menu 115, which would cause a pull down menu to be displayed. In one embodiment, the pull down menu includes a submenu option to allow the developer to specify the development language.

In one embodiment, the resulting application is displayed at run time in English by default, i.e., the default preferred language is English. In an alternate embodiment, a developer may specify a preferred language, which causes the application to be displayed in the specified preferred language at run time (discussed in details below). The preferred language may be input through a menu option similar to those discussed above. In one embodiment, a user executing an application is able to override the preferred language, e.g., by selecting another language.

In one embodiment, the developer saves the GUI 200, with all the user interface objects, including their relative positions within the GUI 200 and their localizable text, collectively referred to herein as a “session,” in a single base file. In one embodiment, the session may be saved, and restored at a later time, through the use of the menu options available on the menu bar 105. In addition, a user may run the application by loading the base file.

As discussed herein, layout systems have employed multiple base files for localization of an application because, often times when a text string of a localizable user interface object is translated from a first to a second language, the resulting text string may be much longer. In turn, the size of the user interface object itself is increased to accommodate the longer, translated text string. This increase in size in turn affects the entire layout. For example, two objects that are positioned in close proximity to one another, once translated and resized, may overlap. As such, a developer adjusted the layout for each language in a respective base file, e.g., by relocating and/or resizing objects in order to accommodate the longer text strings.

U.S. patent application Ser. No. 13/572,551 discloses user interface objects of a layout that are automatically resized and relocated (“auto-layout”) in order to accommodate for changes to one or more objects, e.g., an object increasing in size due to a longer translated text. Employing auto-layout with localization embodiments described herein, the layout system generates a single base file for all the supported languages. The single base file is used for determining how to display the user interface objects in the user interface window, e.g., the base file automatically determines the size and location of each user interface objects within the user interface window even when translated text alters the layout as described herein.

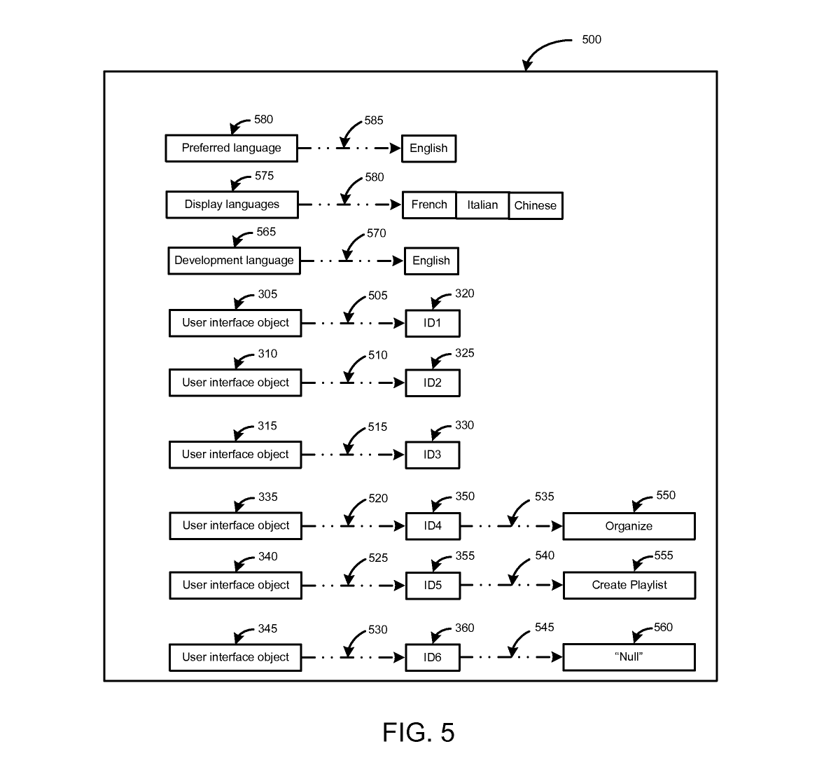

FIG. 5 illustrates an exemplary base file 500 after the developer saves the session as illustrated in FIG. 4. In one embodiment, the base file is periodically saved by the layout system as the developer adds/deletes/modifies the user interface objects in the GUI. In one embodiment, the user instructs the layout system to save the application in a base file through one of the file menu options in the menu bar 105.

In one embodiment, the base file includes data specifying the sizes of the user interface objects and the relative positions of the user interface objects. For instance, the base file 500 of FIG. 5, which stores the layout information of the GUI 200 of FIG. 4, may include information indicating that object 305 is situated to the left of object 310, and that object 310 is situated to the left of object 315, all of which are situated below objects 335, 340, and 345. In one embodiment, the base file also includes pointers, i.e., logical links between the user interface objects and their respective ID's. For example, pointer 505 logically links user interface object 305 to ID1 320. In other words, the base file includes an association between user interface object 305 and the ID1 320. Likewise, pointers 510, 515, 520, 525, and 530 logically link user interface objects 310, 315, 335, 340, and 345 to ID's ID2 325, ID3 330, ID4 350, ID5 355, and ID6 360, respectively. The Development language object 565 has been set to English mode by pointer 570, thus when the localization process is invoked, the translator will know that the text strings in the base file are in English. The base file 500 further includes a display languages object 575, which is logically linked by pointer 580 to French, Italian, and Chinese. Thus, the resulting application can be displayed in English, French, Italian, or Chinese at run time. In one embodiment, the base file 500 includes a preferred language object 580 that indicates the language to display the GUI window 200 and all the user interface objects in, during run time.

In one embodiment, the base file 500 includes pointers that logically link the localizable user interface objects, via their IDs, to their respective text strings (or vice versa). Referring to FIG. 5, pointer 535 logically links the text string “Organize” 550 to user interface object 335 via ID4 350. Similarly, pointer 540 logically links user interface object 340 to the text string “Create Playlist” 555, via ID5 355. Pointer 545 logically links user interface object 345 to a “null” string 560, via ID6 360 because the developer has not provided a text string for the user interface object 345. In one embodiment, the base file 500 does not include logical links that link IDs to text strings. In such an embodiment, the text strings are stored only in the localization text files and are linked to the user interface objects by corresponding IDs in the base file and localization text file. Localization text files are discussed in further detail below.

In one embodiment, the layout system generates only a single base file to be used by the resulting application to determine how to display the user interface objects in the user interface window, for all languages supported by the application. In other words, the application supports multiple display languages and is able to display localizable objects in different preferred languages using a single base file, in conjunction with an appropriate localization text file.

In one embodiment, a localization text file is generated by the layout system for each of the languages that display languages 575 is logically linked to by pointer 580 in the base file 500 of FIG. 5. Generation of localization text files may be initiated in various ways. In one embodiment, the developer initiates the generation of the localization text files through the menu option available on the menu bar 105.

In one embodiment, the generation of the localization text file includes processing of all the user interface objects in the base file to determine if a user interface object is a localizable, e.g., contains text to be translated. In response to determining that a user interface object is localizable, the layout system determines its corresponding ID code. In one embodiment, the text string in the base file associated with the determined ID is translated by the layout system and the translated text and the corresponding ID code are stored in the localization text file.

In one embodiment, the translation is performed on the text of all localizable user interface objects in the base file. In an alternate embodiment, the layout system receives an input specifying which localizable user interface objects are to be/not to be translated. In one embodiment, the user input may specify a particular localizable user interface object that is not to be translated. In an alternate embodiment, the user input specifies an entire class of localizable user interface objects that is not to be translated. For instance, in one embodiment, “round buttons” may be assigned by the layout system to a particular class object, and “square buttons” may be assigned to another class object. In such an embodiment, the user may configure the layout system such that localization is not performed on “square buttons,” or that only “square buttons” are localized, etc.

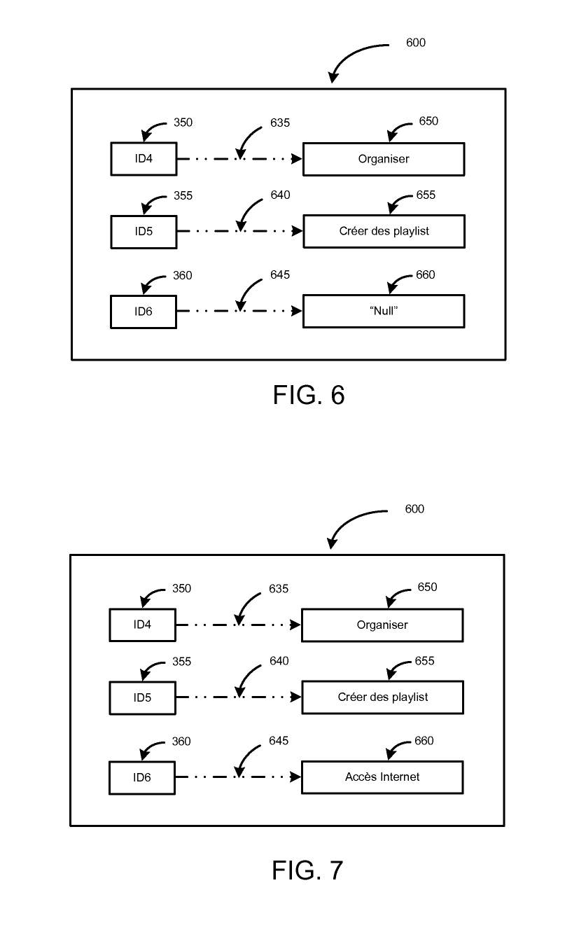

FIG. 6 illustrates an exemplary French localization text file 600 generated according to the base file 500 of FIG. 5. Referring to FIG. 5, there are a total of six user interface objects: 305, 310, 315, 335, 340, and 345, associated with ID's 320, 325, 330, 350, 355, and 360, respectively. In an embodiment of generating the French localization text file 600, the layout system will determine that only ID4 350, ID5 355, and ID6 360 are localizable user interface objects. For instance, the layout system may parse all the subclasses of all the objects in the base file 500, and determine that only user interface objects 335, 340, and 345 include or belong to a special subclass indicating that they contain localizable text. In response to such determination, the text “Organize” 550 of FIG. 5 is translated to French, resulting in the text string “Organiser” 650 of FIG. 6. The translated text is logically linked to its corresponding ID4 350 by pointer 635, and stored in the generated French localization text file 600 as illustrated in FIG. 6. Likewise, the text string “Create Playlist” 555 of the base file 500 in FIG. 5 is translated to French, resulting in the text string “Créer des playlist” 655 of FIG. 6. The translated text is logically linked to its corresponding ID5 355 by pointer 640, and stored in the generated French localization text file 600 as illustrated in FIG. 6. In FIG. 5, a “null” string 560 is logically linked to ID6 360 because the developer did not provide an input text string for the localizable user interface object 355. As a result, there is no translation for user interface object 345, and a “null” text string 660 is logically linked to ID6 by pointer 645, and stored in the French localization text file 600 of FIG. 6. In one embodiment, the translation is performed automatically by the layout system when the user instructs the layout system to generate the localization text file(s).

In one embodiment, the generation of a base file and the localization text files are performed as two distinct steps. It will be appreciated that the base file and the localization text files may be generated by a single step, e.g., an option in a pull down menu of File menu 110 which would generate a base file and all the localization text files.

FIG. 7 illustrates a localization text file 600 of FIG. 6 that has been manually edited. In one embodiment, after the localization text files have been generated as discussed above, a manual modification may be performed on one or more of the generated text strings. Manual edits include correcting translations (e.g., correcting a machine translation) and adding text to an object that would not otherwise include text within the localization text file. For example, the “null” string 660 of FIG. 6 may be manually edited to be “Accès Internet”, resulting in the French localization text file 600 of FIG. 7. As a result, at run time, if the user selects the preferred language to be French, the user interface object 345 will be displayed with the text “Accès Internet” because user interface object 345 has been logically linked to ID6 by pointer 530, which in turn has been logically linked to the text string by pointer 645 in the French localization text file 600 of FIG. 7. It will be appreciated, however, that when the application is run in non-French mode, e.g., English mode, user interface object 345 will not be displayed with any text because the user interface object 345 is still logically linked to ID6 by pointer 530, which in turn is logically linked to a “null” text string 560 by pointer 545 in the base file 500, as illustrated in FIG. 5.

In one embodiment, the entire localization text file is created from scratch manually, rather than being automatically generated and partially edited as discussed above.

In one embodiment, a developer modifies a GUI window 200 and the user interface objects contained therein by opening an existing session. When an existing base file, such as the base file 500 of FIG. 5 is opened, the GUI window 200 of FIG. 4 is displayed in the developer window 100, including the user interface objects 305, 310, 315, 335, 340, and 345, and their respective text strings. After the session is opened, any changes to the user interface can be made. For example, a new user interface object can be added or an existing user interface can be deleted. In one embodiment, the text string of an existing localizable interface object may be edited, added, or deleted.

In one embodiment, the layout system displays the text string exactly as provided in the localization text file or base file. In an alternate embodiment, the text string is repeated predetermined number of times. For example, the layout system may be instructed to display the text string twice, resulting in the text string “Organize” 550 being displayed as “OrganizeOrganize” along with the user interface object 350 in the user interface window. In some instances, a translation may result in a text string which is much longer than the text in the original (development) language, thus causing the object size to increase, which could result in a change in the layout of the objects. Thus, having a feature which causes the text to be displayed a predetermined number of times enables the developer to determine ahead of time whether the layout of the objects may be affected after the translation.

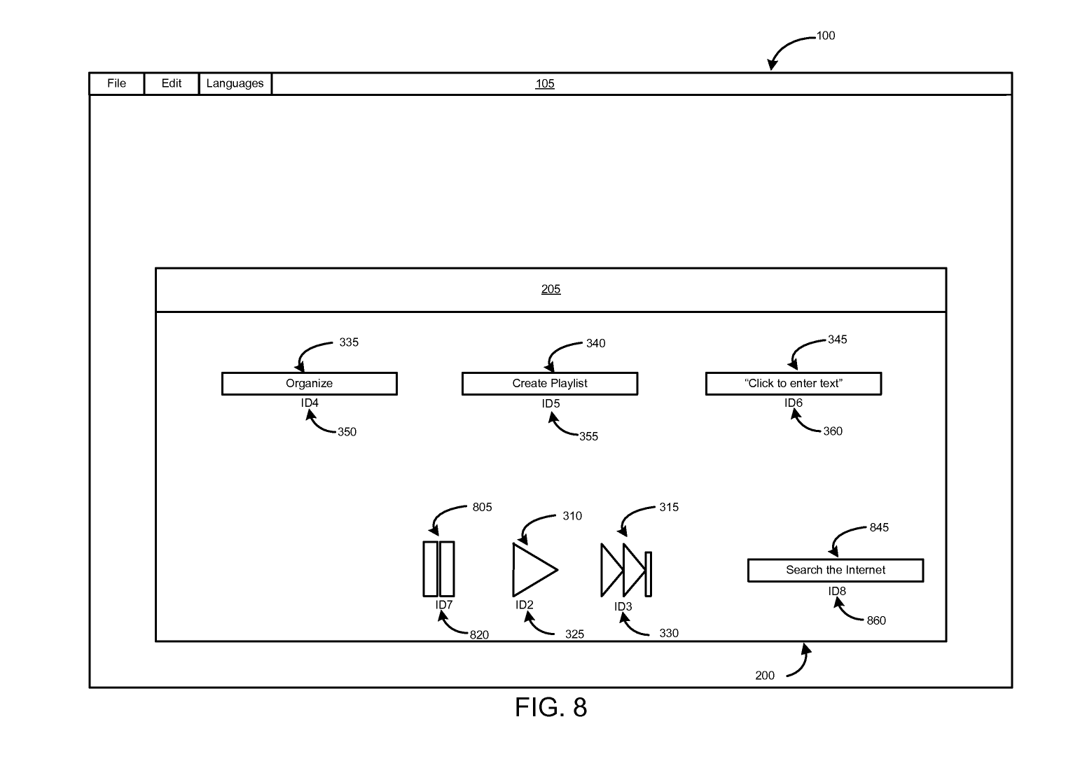

FIG. 8 illustrates the GUI window of 200 of FIG. 4 after a developer has made changes to the session. In particular, user interface object 305 has been deleted, and a new user interface object 805 has been added. In one embodiment, a new unique ID code ID7 820 has been generated and associated with the user interface object 805. FIG. 8 further illustrates that a new localizable user interface object 845 has been added and associated with a new ID8 860. In addition, a text string “Search the Internet” has been added for user interface object 845. Note that localizable user interface object 345 does not include the manually edited text from localization text file 600 of FIG. 7 because the manual edit is not reflected in base file 500 of FIG. 5. Thus, when the session of FIG. 4 is used to regenerate localization text files, manual edited text strings may be lost. This will be discussed in further details below.

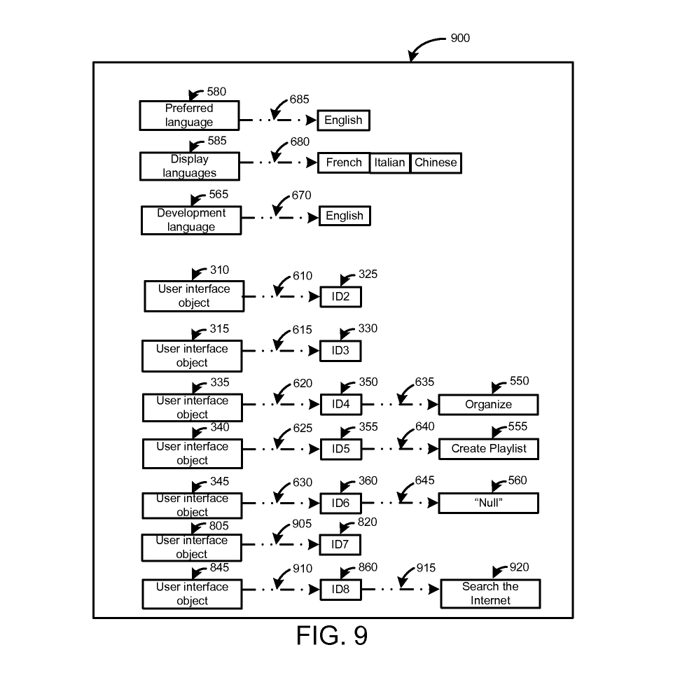

FIG. 9 illustrates a base file 900 that is generated after the session illustrated in FIG. 8 has been saved. User interface object 305 and its corresponding ID1 320 have been removed from the base file. A new non-localizable user interface object 805 of FIG. 8 has been added to the base file 900 and linked to ID7 820 via pointer 905. Similarly, a new localizable user interface object 845 has been added and linked to ID8 860 via pointer 910. The user interface object 845 is also linked to its ID8 860 via link 910, which in turn is linked to the text string “Search the Internet” 920 via pointer 915.

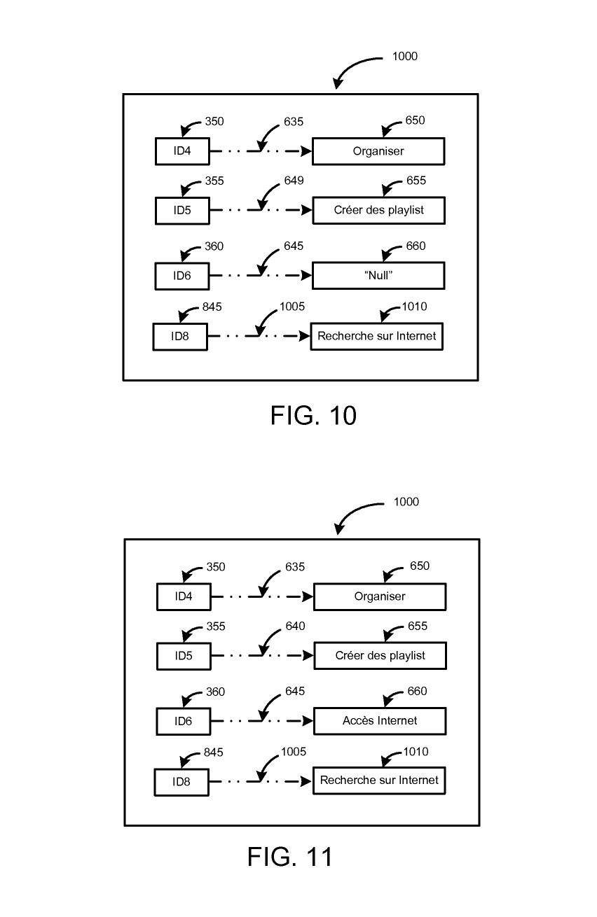

FIG. 10 illustrates a French localization text file that is completely regenerated based on the session illustrated in FIG. 8, saved in the base file 900 of FIG. 9. In one embodiment, a manual edit, e.g., the manually added text string “Accès Internet” 660 of the French localization text file 600 of FIG. 7, is replaced by the “null” string 660 in the base file 900 of FIG. 9. The existing French localization text file is overwritten by a completely newly generated localization text file, according to the latest session as illustrated in the base file 900 of FIG. 9. Previous manual edits to the localization text file 600 are lost. Additionally, text strings “Organiser” 650, “Créer des playlist” 655, and “Recherche sur Internet” 1010 have been generated and logically linked to ID4 350, ID5 355, and ID8 845, respectively, as illustrated in FIG. 10.

FIG. 11 illustrates a French localization text file that is partially regenerated based on the session illustrated in FIG. 8 as saved in the base file 900 of FIG. 9. In one embodiment, only the user interface objects that have been modified since that last session will be regenerated in the updated localization text file. For example, the text string “Accès Internet” that was manually added in the French localization text file 600 of FIG. 7, but not reflected in the latest base file 900 of FIG. 9, will not be overwritten to be a “null” string, because the developer has not modified the text string of user interface object 345 (i.e., the developer has left the text as “null”). On the other hand, localizable user interface object 845 is a user interface object that has been added since the session was last saved in the base file 900. As a result, object 845 is linked to the text string “Recherche sur Internet” 1010 by pointer 1005. The association of object 845 to its text string is then stored in the localization text file 1000, which is an updated version of the localization text file 600 of FIG. 7.

In one embodiment, a localization text file is also generated for the default development language. For instance, in the case of an application having the base file 900 of FIG. 9, an English localization text file may be generated because the development language has been set to English despite the fact that the base file is in developed in English. In one embodiment, the English localization text file is generated even though the display languages object does not include English as one of its display languages. The generation of localization text file for the default development language provides a way to modify the English text without editing the base file.

In one embodiment, opening an existing session includes opening not only the base file, but also determining if a localization text file in the development language exists, and if so, override the text in the base file with the text from the localization text file. By way of example, when an existing base file is opened, the base file indicating that the layout and text was developed in English, the layout system determines if an English localization text file exists. If an English localization text file exists, the computer displays the text strings from the localization text file along with the localizable user interface objects in the user interface window, rather than the text strings from the base file. This enables the developer to edit the session with the most up to date text strings. In one embodiment, the base file syncs up to the localization text file when the session is saved. This allows the generation of other localization text files to be based on the latest English text in the base file.

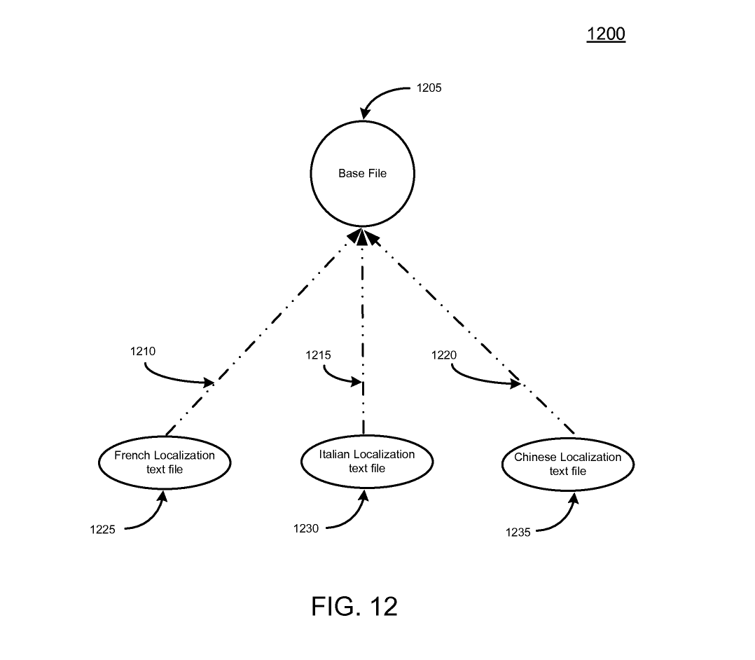

FIG. 12 illustrates a file referencing structure of an application 1200 that results from the development of the exemplary GUI window of FIG. 8. The base file 1205 has been generated as discussed above, and contains the data necessary for rendering the GUI window 200 and all the user interface objects contained therein. In the application 1200, the set of display languages include French, Italian, and Chinese. As a result, the computer has generated a French localization text file 1225, an Italian localization text file 1230, and a Chinese localization text file 1235. A logical link 1210 exists between the base file 1205 and the French localization text file that allows the base file 1205 to access the French localization text file if necessary. Likewise, logical links 1215 and 1220 exist between the base file 12051105 and the Italian localization text file 1230 and the Chinese localization text file 1235, respectively.

In one embodiment, the application is displayed in the preferred language that is saved in the base file. In another embodiment, the preferred language setting is provided by the operating system of the electronic system on which the application 1200 is executed. In one embodiment, the user provides the preferred language to the application, e.g., through a file menu option that is part of the GUI of the application 1200. In one embodiment, the user configures the application 1200 to automatically select the preferred language that was used during the last execution of the application 1200. In one embodiment, the configuration is achieved through a menu option that is part of the GUI of the application 1200.

In one embodiment, when the application is executed, the application determines that the preferred language and the development language are not the same language. For example, the preferred language may be French, while the development language is English. In response to determining that the preferred language and the development language are not the same language, the application performs the localization process by determining the ID codes of all the localizable user interface objects in the base file. By way of example, the computer would determine that ID4 350, ID5 355, ID6 360, and ID8 860 in base file 900 of FIG. 9 link to localizable user interface objects.

In one embodiment, the computer determines whether a user interface object is localizable by determining whether the user interface object includes/belongs to a special subclass, as discussed herein.

Upon completing the determining of which ID codes in the base file link to localizable user interface objects, the execution of the application 1200 further includes accessing a localization text file. In one embodiment, the localization text file to be accessed is based on the preferred language received by the computer. For example, if the preferred language is French, the logical link 1200 of FIG. 12 would be enabled, allowing the base file 1205 to access the French localization text file 1225 as illustrated in FIG. 12.

In one embodiment, the application provides a notification when a localization text file that needs to be accessed is not available. In one embodiment, the notification includes displaying a warning message in the user interface window.

In one embodiment, the computer accesses an alternate localization text file. In an alternate embodiment, the computer displays the text strings contained in the base file.

In one embodiment, for each of the ID code in the base file that was identified as being linked to localizable user interface objects, the computer determines a text string in the accessed localization text file that is associated with the ID code. For example, for the identified ID4 350 of base file 900 of FIG. 9, the computer determines that the associated text string in the French localization text file 1000 is “Organiser” 650, as illustrated in FIG. 11. The computer substitutes the text string in the base file associated with the ID code, with the text string from the localization text file. For example, the computer substitutes the text string “Organize” 550 of the base file 900 in FIG. 9, with the text string “Organiser” 650 from the French localization text file 1000 in FIG. 11. In one embodiment, the base file does not include text strings. In such an embodiment, the layout system simply displays the text string from the localization text file along with the corresponding localizable user interface object.

In one embodiment, the computer determines if all localizable text strings in the base file 900 have been substituted with the text strings from the localization text file, according to the ID codes in the base file that have been determined to link to localizable user interface objects. If there remains one or more text strings to be substituted, the above process would be repeated. However, if all text strings have been substituted, the computer generates a user interface window with the localizable user interface objects including the text from the localization text file.

In one embodiment, when executed, the application 1200 performs the above localization process even if the received preferred language matches the development language. For example, the application 1200 determines the ID codes of the localizable objects in the base file and substitutes their text strings with the text strings in a localization text file selected based on the preferred language.

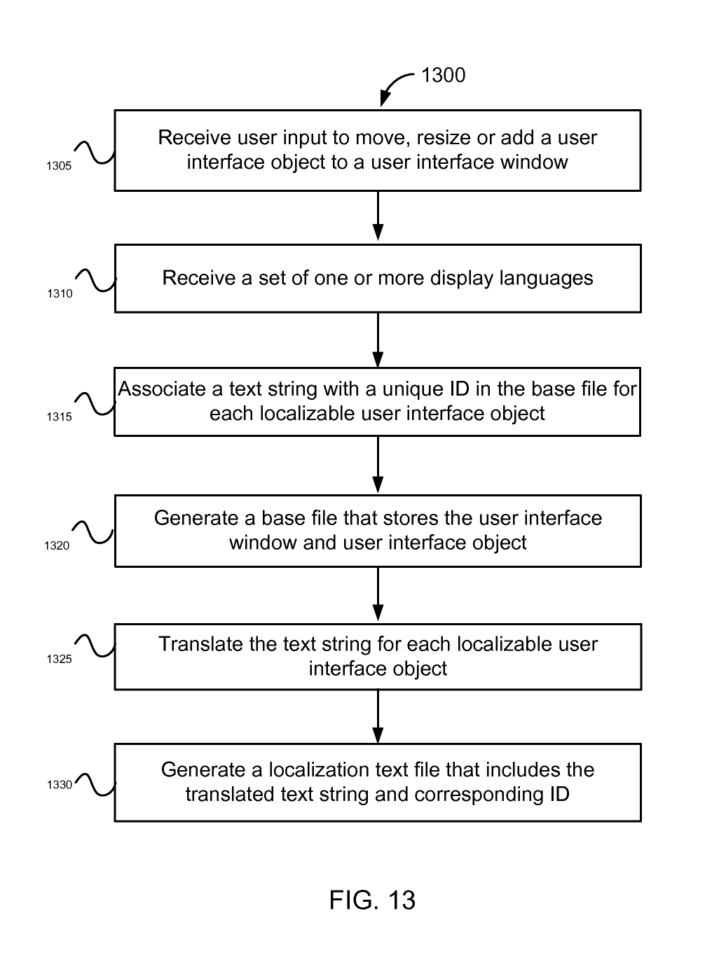

FIG. 13 is a flow chart that illustrates an exemplary computer-implemented method 1300 of generating a single base file and a plurality of localization text files according to the discussion above relating to FIGS. 1-8.

At block 1305, the computer receives a user input to move, resize, or add a user interface object to a user interface window, e.g., as described in the text above relating to FIG. 3. In one embodiment, the user interface object is a localizable user interface object. In one embodiment, when a localizable user interface object is initially added to a user interface window, the text string is null. The null string can be overridden by a user-inputted text string. In one embodiment, a user interface object received by the computer is non-localizable, e.g., the object does not include a translatable text string to be displayed along with the user interface object.

At block 1310, the computer receives as input a set of one or more display languages, which indicates what language or languages the application may be displayed in at run time.

At block 1315, the computer generates a unique ID code for each user interface object that is added to the user interface window. In one embodiment, ID's are unique to each session and are reused, e.g., upon deletion of an user interface object that previously used an ID. Alternatively, an ID is not reused, even if the user interface object has been deleted from the user interface window.

At block 1320, the computer generates a single base file, e.g., as discussed with reference to FIG. 5 above. In one embodiment, the information stored in the base file captures all the relevant data necessary to reproduce an image of the user interface window and all the user interface objects. In one embodiment, this single base file is used for the display of the objects in the user interface window for all the supported display languages. In one embodiment, the data stored in the base file includes, e.g., the development language object that indicates the language in which the localizable text was received by the computer. In one embodiment, the base file includes the display languages object, which is logically linked to the languages received at block 1310. In one embodiment, the base file includes the preferred language object, which indicates the language in which the application is to be displayed at run time. The objects stored in the base file discussed above are only intended to be for illustrative purposes, and the base file is not limited to the examples above. It will be appreciated that the base file may include more or less information than those described above.

At block 1325, the computer processes the user interface objects in the base file to determine which user interface objects are localizable. For each localizable user interface object, the computer determines its corresponding ID code in the base file, and translates the text string to a language in one of the set of display languages received at block 1310. In one embodiment, the text of every localizable user interface object is translated. In another embodiment, the text of one or more localizable user interface objects is not translated.

At block 1330, the computer generates a localization file containing the ID codes of the localizable user interface objects, and their respective text strings as translated at block 1325. In one embodiment, a localization file is generated for each of the display languages received at block 1310.

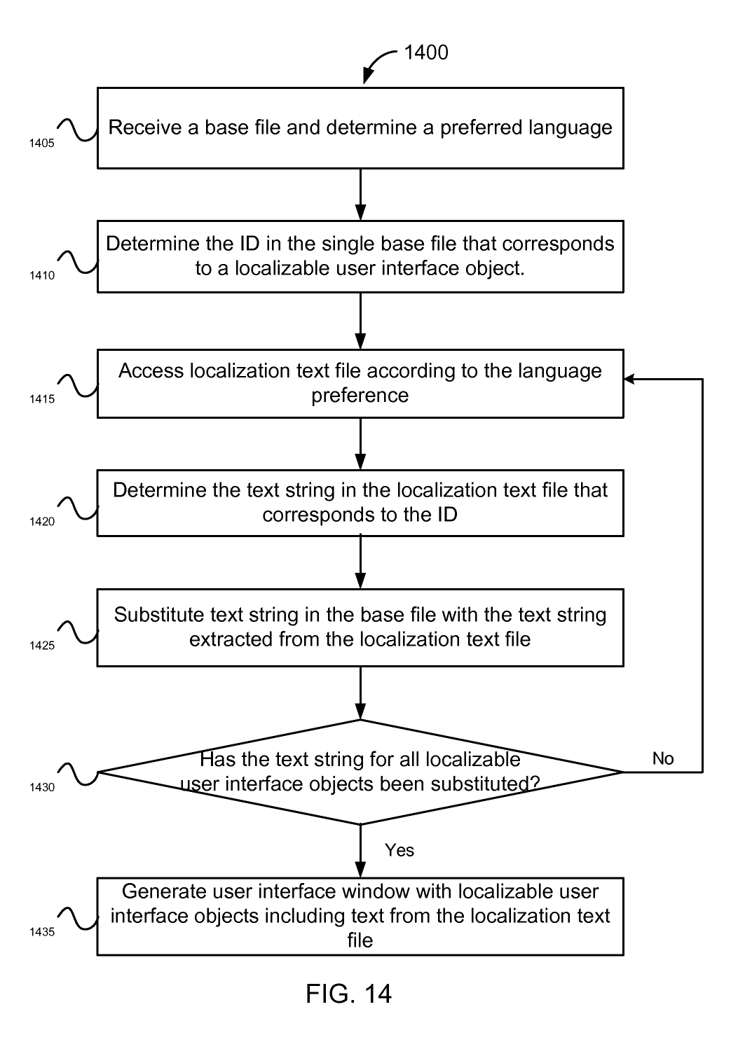

FIG. 14 is a flow chart that illustrates an exemplary method 1400 of generating a user interface window and user interface objects with their respective text. At block 1405, the computer receives a single base file and determines a preferred language. In one embodiment, this single base file contains the information necessary for rendering the physical layout of all the user interface objects in all the supported display languages. In other words, the user interface window with all the user interface objects can be rendered for all the supported display languages using this single base file.

At block 1410, the computer determines that the preferred language is not the same as the development language set in the base file. As a result, the computer determines the ID codes of all the localizable user interface objects in the base file. By way of example, the computer determines that ID4 350, ID5 355, ID6 360, and ID8 860 of FIG. 9 link to localizable user interface objects.

At block 1415, the computer accesses a localization text file, in response to determining that the preferred language is not the same as the development language. For instance, if the development language is English and the preferred language is French, the logical link 1210 of FIG. 12 would be enabled, allowing the base file to access the French localization text file.

At block 1420, the computer determines a text string in the localization text file that corresponds to the ID code determined at block 1410. By way of example, the computer determines that the text string “Organiser” 650 corresponds to ID4 350, i.e., ID4 350 is associated with the text string “Organiser” 650.

At block 1425, the computer substitutes the text string in the base file with the text string from the localization text file. Continuing with the example above, the computer substitutes the text string “Organize” 550 in the base file 900 of FIG. 9, with the text string “Organiser” 650 in the French localization text file 1000 in FIG. 11, in response to determining that both strings are logically linked to the same ID4 350.

At block 1430, the computer determines if all localizable text strings in the base file 900 have been substituted with the text strings from the localization text file, according to their ID codes. In the event that the computer determines that at least one or more of the localizable text strings in the base file has not be substituted with a respective text string in the localization text file, the computer returns back (i.e., loops back) to block 1415, and proceed as discussed above for another text string. If the computer determines that all localizable text strings in the base file have been substituted with a text string in the localization text file corresponding to their ID codes, the computer proceeds to block 1435.

At block 1435, the computer generates the user interface window with the localizable user interface objects including the text from the localization text file as discussed above.

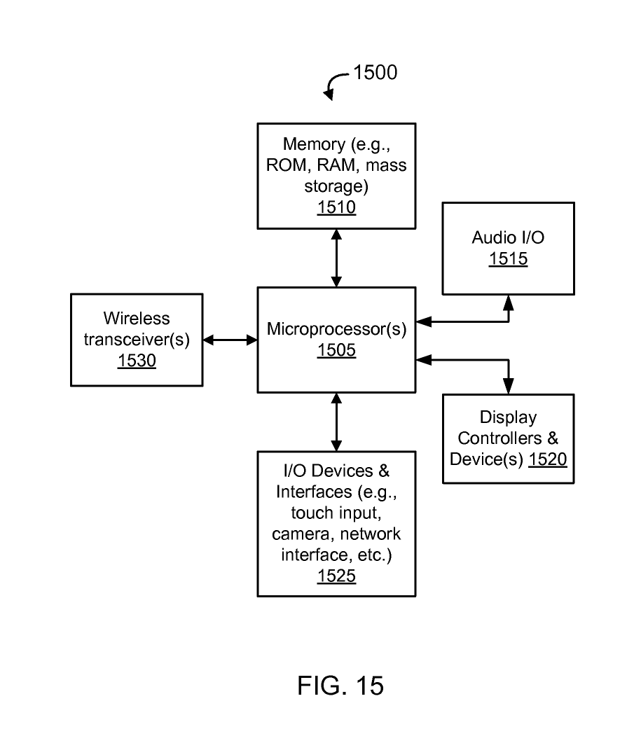

FIG. 15 illustrates, in block diagram form, an exemplary data processing system 100 that automates the layout of a graphical user interface, as described above. Data processing system 1500 may include one or more microprocessors 1505 and connected system components (e.g., multiple connected chips) or the data processing system 1500 may be a system on a chip.

The data processing system 1500 includes memory 1510, which is coupled to the microprocessor(s) 1505. The memory 1510 may be used for storing data, metadata, and programs for execution by the microprocessor(s) 1505. The memory 1510 may include one or more of volatile and non-volatile memories, such as Random Access Memory (“RAM”), Read Only Memory (“ROM”), a solid state disk (“SSD”), Flash, Phase Change Memory (“PCM”), or other types of data storage.

The data processing system 100 also includes an audio input/output subsystem 1515 which may include a microphone and/or a speaker for, for example, playing back music, providing telephone or voice/video chat functionality through the speaker and microphone, receiving voice instructions to be executed by the microprocessor(s) 1505, playing audio notifications, etc.

A display controller and display device 1520 provides a visual user interface for the user; this user interface may include a graphical user interface which, for example, is similar to that shown on a Macintosh computer when running Mac OS operating system software or an iPad, iPhone, or similar device when running iOS operating system software.

Data processing system 1500 also includes one or more wireless transceivers 1530, such as an IEEE 802.11 transceiver, an infrared transceiver, a Bluetooth transceiver, a wireless cellular telephony transceiver (e.g., 1G, 2G, 3G, 4G), or another wireless protocol to connect the data processing system 1500 with another device, external component, or a network.

It will be appreciated that one or more buses, may be used to interconnect the various components shown in FIG. 15.

The data processing system 1500 may be a personal computer, tablet-style device, such as an iPad, a personal digital assistant (PDA), a cellular telephone with PDA-like functionality, such as an iPhone, a Wi-Fi based telephone, a handheld computer which includes a cellular telephone, a media player, such as an iPod, an entertainment system, such as a iPod touch, or devices which combine aspects or functions of these devices, such as a media player combined with a PDA and a cellular telephone in one device. In other embodiments, the data processing system 1500 may be a network computer or an embedded processing device within another device or consumer electronic product. As used herein, the terms “computer” and “apparatus comprising a processing device” may be used interchangeably with the data processing system 1500 and include the above-listed exemplary embodiments.

The system 1500 also includes one or more input or output (“I/O”) devices and interfaces 1525 which are provided to allow a user to provide input to, receive output from, and otherwise transfer data to and from the system. These I/O devices may include a mouse, keypad or a keyboard, a touch panel or a multi-touch input panel, camera, network interface, modem, other known I/O devices or a combination of such I/O devices. The touch input panel may be a single touch input panel which is activated with a stylus or a finger or a multi-touch input panel which is activated by one finger or a stylus or multiple fingers, and the panel is capable of distinguishing between one or two or three or more touches and is capable of providing inputs derived from those touches to the processing system 1500. The I/O devices and interfaces 1525 may also include a connector for a dock or a connector for a USB interface, FireWire, Thunderbolt, Ethernet, etc. to connect the system 1500 with another device, external component, or a network.

It will be appreciated that additional components, not shown, may also be part of the system 1500, and, in certain embodiments, fewer components than that shown in FIG. 15 may also be used in a data processing system 1500. It will be apparent from this description that aspects of the inventions may be embodied, at least in part, in software. That is, the computer-implemented methods described herein may be carried out in a computer system or other data processing system in response to its processor or processing system executing sequences of instructions contained in a memory, such as memory 1510 or other machine-readable storage medium. The software may further be transmitted or received over a network (not shown) via a network interface device 1525. In various embodiments, hardwired circuitry may be used in combination with the software instructions to implement the present embodiments. Thus, the techniques are not limited to any specific combination of hardware circuitry and software, or to any particular source for the instructions executed by the data processing system 1500. As used herein, the term “computer” may refer to data processing system 100 and the various embodiments of data processing system 1500 described above.

In the foregoing specification, the invention has been described with reference to specific exemplary embodiments thereof. It will be evident that various modifications may be made thereto without departing from the broader spirit and scope of the invention as set forth in the following claims. For example, the methods described herein may be performed with fewer or more features/blocks or the features/blocks may be performed in differing orders. Additionally, the methods described herein may be repeated or performed in parallel with one another or in parallel with different instances of the same or similar methods. An article of manufacture may be used to store program code providing at least some of the functionality of the embodiments described above. Additionally, an article of manufacture may be used to store program code created using at least some of the functionality of the embodiments described above. An article of manufacture that stores program code may be embodied as, but is not limited to, one or more memories (e.g., one or more flash memories, random access memories—static, dynamic, or other), optical disks, CD-ROMs, DVD-ROMs, EPROMs, EEPROMs, magnetic or optical cards or other type of non-transitory machine-readable media suitable for storing electronic instructions. Additionally, embodiments of the invention may be implemented in, but not limited to, hardware or firmware utilizing an FPGA, ASIC, a processor, a computer, or a computer system including a network. Modules and components of hardware or software implementations can be divided or combined without significantly altering embodiments of the invention. The specification and drawings are, accordingly, to be regarded in an illustrative sense rather than a restrictive sense.

What is claimed is:

1. A computer-implemented method comprising:
receiving, by the computer, a preferred language and a single base file, wherein the single base file comprises one or more user interface objects, wherein the one or more user interface objects includes a localizable user interface object, wherein the localizable user interface object is a user interface object that includes a text string to be replaced based upon the preferred language, wherein the single base file contains information for rendering a physical layout of the one or more user interface objects in a user interface window for a plurality of languages;
determining, by the computer, that a user interface object in the single base file is the localizable user interface object;
determining, by the computer, an identification (ID) code in the single base file, that corresponds to the localizable user interface object, in response to determining that the user interface object is the localizable user interface object;
accessing, by the computer, a localization text file according to the preferred language;
determining, by the computer, a text string in the localization text file that corresponds to the ID code;
substituting, by the computer, the text string for the localizable user interface object in the single base file with the text string from the localization text file; and
generating, by the computer, the user interface window with the localizable user interface object according to the single base file, including the text from the localization text file.

2. The method of claim 1, wherein the preferred language is provided by a user input.

3. The method of claim 1, wherein the determining of whether the user interface object in the single base file is a localizable user interface object includes a determination that the user interface object includes a particular subclass.

4. The method of claim 1, wherein the single base file further comprises a non-localizable user interface object, wherein the non-localizable user interface is a user interface object that does not include text to be translated.

5. The method of claim 1, further comprising receiving, by the computer, a user command not to substitute the text string for a particular localizable user interface object.

6. A computer-implemented method comprising:
receiving, by the computer, user input to move, resize, or add one or more user interface objects to a user interface window, wherein the one or more user interface objects includes a localizable user interface object, wherein a localizable user interface object is a user interface object that includes text to be translated;
receiving, by the computer, a set of at least one or more display languages, such that the user interface window and the localizable user interface objects can be displayed in one of the at least or more languages;
generating, by the computer, a single base file that stores the user interface window and the localizable user interface objects, wherein the base file associates the localizable user interface object with a unique identification (ID) code, and a text string;
determining, by the computer, that a user interface object in the base file is the localizable user interface object;
determining, by the computer, the ID code in the base file that corresponds to the localizable user interface object, in response to determining that the user interface object is the localizable user interface object; and
generating, by the computer, a localization text file for a language selected from the set of at least one or more display languages, wherein the localization text file contains the ID code corresponding to the localizable user interface object, and a translated text string to be displayed with the localizable user interface object in the user interface window, such that the user interface window and the localizable user interface objects are displayed according to the base file, and the text of the localizable user interface objects are displayed according to the text from a localization text file selected based on a selected display language.

7. The method of claim 6, wherein the base file stores a non-localizable user interface object, wherein a non-localizable interface object is a user interface object that does not include text to be translated.

8. The method of claim 6, wherein the text string generated in the localization text file is the text string in the base file corresponding to the ID code of the localizable user interface object that is translated, by the computer, to the language selected from the set of at least one or more display languages.

9. A non-transitory machine-readable medium storing instructions that, when executed, cause a processing device to perform a method comprising:
receiving, by the processing device, a preferred language and a single base file, wherein the single base file comprises one or more user interface objects, wherein the one or more user interface objects includes a localizable user interface object, wherein the localizable user interface object is a user interface object that includes a text string to be replaced based upon the preferred language, wherein the single base file contains information for rendering a physical layout of the one or more user interface objects in a user interface window for a plurality of languages;
determining, by the processing device, that a user interface object in the single base file is the localizable user interface object;
determining, by the processing device, an identification (ID) code in the single base file, that corresponds to the localizable user interface object, in response to determining that the user interface object is the localizable user interface object;
accessing, by the processing device, a localization text file according to the preferred language;
determining, by the processing device, a text string in the localization text file that corresponds to the ID code;
substituting, by the processing device, the text string for the localizable user interface object in the single base file with the text string from the localization text file; and
generating, by the processing device, the user interface window with the localizable user interface object according to the single base file, including the text from the localization text file.

10. The non-transitory machine-readable medium of claim 9, wherein the preferred language is provided by a user input.

11. The non-transitory machine-readable medium of claim 9, wherein the determining of whether the user interface object in the single base file is a localizable user interface includes a determination that the user interface object includes a particular subclass.

12. The non-transitory machine-readable medium of claim 9, wherein the single base file further comprises a non-localizable user interface object, wherein the non-localizable user interface object is a user interface object that does not include text to be translated.

13. The non-transitory machine-readable medium of claim 9, wherein the instructions, when executed, cause the processing device to perform a method further comprising:
receiving, by the processing device, a user command not to substitute the text string for a particular localizable user interface object.

14. An apparatus comprising:
a processing device, wherein the processing device executes instructions that cause the processing device to
receive preferred language and a single base file, wherein the single base file comprises one or more user interface objects, wherein the one or more user interface objects includes a localizable user interface object, wherein the localizable user interface object is a user interface object that includes a text string to be replaced based upon the preferred language, wherein the single base file contains information for rendering a physical layout of the one or more user interface objects in a user interface window for a plurality of languages;
determine that a user interface object in the single base file is the localizable user interface object;
determine an identification (ID) code in the single base file, that corresponds to the localizable user interface object, in response to determining that the user interface object is the localizable user interface object;
access a localization text file according to the preferred language;
determine a text string in the localization text file that corresponds to the ID code;
substitute the text string for the localizable user interface object in the single base file with the text string from the localization text file; and
generate the user interface window with the localizable user interface object according to the single base file, including the text from the localization text file.

15. The apparatus of claim 14, wherein the preferred language is provided by a user input.

16. The apparatus of claim 15, wherein the determining of whether the user interface object in the single base file is a localizable user interface object includes a determining that the user interface object includes a particular subclass.

17. The apparatus of claim 16, wherein the base file further comprises a non-localizable user interface object, wherein the non-localizable user interface is a user interface object that does not include text to be translated.

18. The apparatus of claim 17, further comprising receiving, by the processing device, a user command not to substitute the text string for a particular localizable user interface object.

19. A non-transitory machine-readable medium storing instructions that, when executed, cause a processing device to perform a method comprising:
receiving, by the processing device, user input to move, resize, or add one or more user interface objects to a user interface window, wherein the one or more user interface objects includes a localizable user interface object, wherein a localizable user interface object is a user interface object that includes text to be translated;
receiving, by the processing device, a set of at least one or more display languages, such that the user interface window and the localizable user interface objects can be displayed in one of the at least or more languages;
generating, by the processing device, a single base file that stores the user interface window and the localizable user interface objects, wherein the base file associates the localizable user interface object with a unique identification (ID) code, and a text string;
determining, by the processing device, that a user interface object in the base file is the localizable user interface object;
determining, by the processing device, the ID code that in the base file that corresponds to the localizable user interface object, in response to determining that the user interface object is the localizable user interface object; and
generating, by the processing device, a localization text file for a language selected from the set of at least one or more display languages, wherein the localization text file contains the ID code corresponding to the localizable user interface object, and a translated text string to be displayed with the localizable user interface object in the user interface window, such that the user interface window and the localizable user interface objects are displayed according to the base file, and the text of the localizable user interface objects are displayed according to the text from a localization text file selected based on a selected display language

20. An apparatus comprising:
a processing device, wherein the processing device executes instructions that cause the processing device to
receive user input to move, resize, or add one or more user interface objects to a user interface window, wherein the one or more user interface objects includes a localizable user interface object, wherein a localizable user interface object is a user interface object that includes text to be translated;
receive a set of at least one or more display languages, such that the user interface window and the localizable user interface objects can be displayed in one of the at least or more languages;
generate a single base file that stores the user interface window and the localizable user interface objects, wherein the base file associates the localizable user interface object with a unique identification (ID) code, and a text string;
determine that a user interface object in the base file is the localizable user interface object;
determine the ID code in the base file that corresponds to the localizable user interface object, in response to determining that the user interface object is the localizable user interface object; and
generate a localization text file for a language selected from the set of at least one or more display languages, wherein the localization text file contains the ID code corresponding to the localizable user interface object, and a translated text string to be displayed with the localizable user interface object in the user interface window, such that the user interface window and the localizable user interface objects are displayed according to the base file, and the text of the localizable user interface objects are displayed according to the text from a localization text file selected based on a selected display language.
